(19) United States
(12) Patent Application Publication
(10) Pub. No.: US 2009/0165759 A1
(43) Pub. Date: Jul. 2, 2009

(54) Fuel management for vehicles equipped with multiple tanks for different grades of fuel

(76) Inventors: Bhaskar Sengupta, Princeton Junction, NJ (US); Krishnan Kumaran, Raritan, NJ (US); Walter Weissman, Basking Ridge, NJ (US); Randall D. Partridge, Califon, NJ (US)

Correspondence Address: ExxonMobil Research and Engineering Company, P.O. Box 900, Annandale, NJ, 08801-0900, US

(21) Appl. No.: 12/316,031

(22) Filed: Dec. 19, 2008

Related U.S. Application Data
(60) Provisional application No. 61/009,336, filed on Dec. 27, 2007.

(51) Int. Cl. F02D 41/00; F02B 43/00

(52) U.S. Cl. 123/575; 701/103

(57) ABSTRACT

A fuel management system mounted on a vehicle is operative to feed an individual grade or a mixture of grades of relatively low, intermediate, and high RON fuels, from respective tanks to an associated internal combustion engine. The system includes an on board separation unit (OBS unit) for receiving and separating intermediate RON fuel, from an IRON tank into low and high RON fuels, LRON and HRON, respectively, for delivery to LRON and HRON tanks, respectively. The production rate of the LRON and HRON fuels by the OBS unit is controlled to substantially match the consumption requirements of the engine at any given time for the LRON and HRON fuels.

This application claims the benefit of U.S. Provisional Application No. 61/009,336 filed Dec. 27, 2007.

### RELATED APPLICATIONS

The present invention is related to U.S. Provisional Application No. 61/009,266, entitled “Multiple Fuel System For Internal Combustion Engines,” filed on the same day herewith, having common inventorship herewith, and common ownership; to Ser. No. 11/187,672, filed on Jul. 22, 2005, for “Heat Pipe For Self Limiting Heating Of Gasoline For Onboard Octane Segregation”; and to Provisional Application No. 60/785,426, filed on Mar. 24, 2006, for “Heat Pipe With Controlled Fluid Charge.” The teachings of the related Applications are incorporated by reference herein to the extent that they do not conflict herewith.

### FIELD OF THE INVENTION

The present invention relates generally to systems for using multiple fuel of differing grades, such as different research octane numbers (RON) for spark ignition engines, and different cetane numbers for compression ignition engines, either individually or in a predetermined mixture for operating an internal combustion engine.

### BACKGROUND OF THE INVENTION

Both petroleum refineries and engine manufacturers are constantly faced with the challenge of continually improving their products to meet increasingly severe governmental efficiency and emission requirements, and consumers' desires for enhanced performance. For example, in producing a fuel suitable for use in an internal combustion engine, petroleum producers blend a plurality of hydrocarbon containing streams to produce a product that will meet governmental combustion emission regulations and the engine manufacturers performance fuel criteria, such as research octane number (RON). Similarly, engine manufacturers conventionally design spark ignition type internal combustion engines around the properties of the fuel. For example, engine manufacturers endeavor to inhibit to the maximum extent possible the phenomenon of auto-ignition which typically results in knocking, and can cause engine damage, when a fuel with insufficient knock-resistance is combusted in the engine.

Under typical driving situations, engines operate under a wide range of conditions depending on many factors including ambient conditions (air temperature, humidity, etc.), vehicle load, speed, gear ratio, rate of acceleration, and the like. Engine manufacturers and fuel blenders have to design products which perform well under virtually all such diverse conditions. This requires compromise, as often times fuel properties or engine parameters that are desirable under certain speed/load conditions prove detrimental to overall performance at other speed/load conditions. Conventionally, vehicular fuels are supplied in two or three grades, typically distinguished by their Research Octane Number, or RON. Generally, the selection of fuel grade is based upon the engine specifications. However, once the fuel is “onboard,” it becomes a “one fuel fits all” and must be designed to accommodate diverse speed, load and other driving conditions.

Attempts have been made to overcome the limitations of providing only a single grade of fuel for driving an internal combustion engine. In such attempts, systems have been developed for providing multiple fuels of different RON numbers “onboard” a vehicle, for driving the associated internal combustion engine with individual ones or mixtures of the fuels in a controlled manner for meeting the engine's drive cycle conditions over a broad range of operating conditions of the engine. Although these prior systems do offer an enhanced performance of an internal combustion engine, it is clear to those of skill in the art that such systems require further improvement.

### SUMMARY OF THE INVENTION

An object of the present invention is to provide for both production and consumption control of a plurality of fuels having differing RON numbers for optimizing the operation of an internal combustion engine.

An object of the present invention is to provide an improved multiple RON fuel supply system that includes an onboard separation (OBS) unit for separating intermediate research octane (IRON) fuel from a main tank into different grades, one a high research octane (HRON) for delivery to an HRON tank, and the other low research octane (LRON) for delivery to an LRON tank, whereby the production of these fuels by the OBS unit, and their consumption are controlled for delivery from their associated tanks to an associated internal combustion engine in response to the engine's operating conditions.

Another object of the invention is to provide a multiple fuel delivery system for driving an internal combustion engine, wherein the consumption of these fuels either individually or in various mixtures is controlled through use of an optimal RON map, the latter providing mapping of engine operating parameters such as torque, speed, gear ratio, accelerator, and velocity, and so forth, to the RON fuel required by the internal combustion engine over a range of engine drive cycle conditions. Also, the control is programmed to vary the production of the LRON and HRON from the OBS as a function of the fuel consumption by the engine at any given time.

### BRIEF DESCRIPTION OF THE DRAWINGS

Various embodiments of the present invention are described with reference to the drawings, in which like items are identified by the same reference designation, wherein:

FIG. 1 is a simplified block schematic diagram of a fuel management system for one embodiment of the invention;

FIG. 2 shows an optimized research octane number (RON) map plotting torque versus engine speed for showing under ideal circumstances, the fuel RON for providing maximum engine performance for a particular combination of torque value and engine speed, for a preferred embodiment of the invention;

FIG. 3 shows a table for a control algorithm for an embodiment of the invention;

FIG. 4 shows a flowchart for a control algorithm for an embodiment of the invention;

FIG. 5 shows a block schematic diagram of a fuel management system for one embodiment of the invention;

FIG. 6 shows a flowchart for an algorithm for another embodiment of the invention in which torque and speed requirements of an engine can be met through use of low research octane number (LRON) fuel alone;

FIG. 7 is a plot of torque versus engine speed relative to fuel consumption and the fuel utilized, for an embodiment of the invention;

FIG. 8A shows various aspects of the design for a two-way piston accumulator for an embodiment of the invention;

FIG. 8B shows a plot of flow rate versus time versus accumulator piston position for an actual experimental vehicle test of an embodiment of the invention;

FIG. 9 shows a simplified block schematic diagram of a membrane separation process using a mixed vapor liquid feed, for an embodiment of the invention;

FIG. 10A shows a pictorial view of a polymer-coating inorganic membrane for separating aromatic and aliphatic compounds, for a preferred embodiment of the invention; and

FIG. 10B shows an enlarged view of a portion of the front end of the polymer-coated inorganic membrane of a 10A.

### DETAILED DESCRIPTION OF THE INVENTION

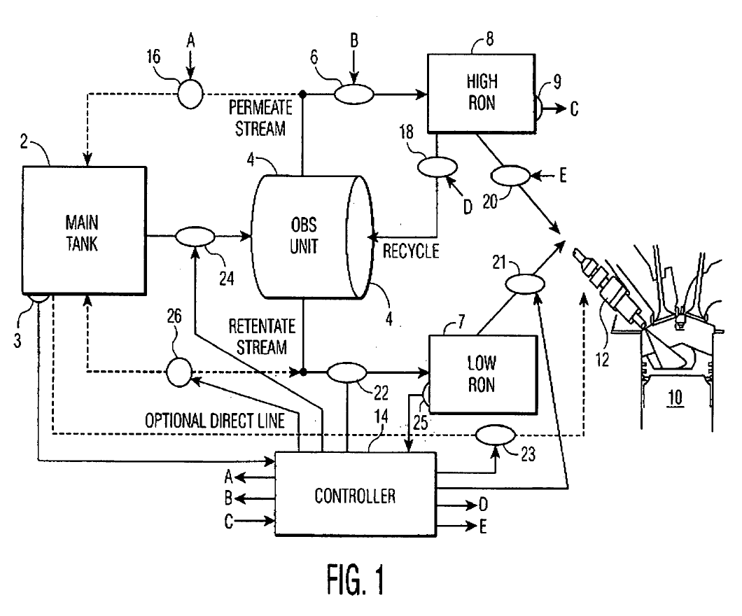

With reference to FIG. 1, a simplified block diagram of a fuel management system for one embodiment of the invention is shown. A main tank 2 for retaining an intermediate grade of Research Octane Number (RON) fuel is included in the associated vehicle. In this example, the intermediate RON (hereinafter IRON) fuel is 91 RON. A variable ratio pump 24 is operable for delivering the IRON fuel from the main tank 2 in a volume rate ranging from 0.5 to 1.5 grams per second (g/s), to an onboard separation (OBS) unit 4. The OBS unit 4 is operable for separating the IRON fuel into two grades, one being a high research octane (HRON) grade fuel, and the other being a low research octane (LRON) fuel. The OBS unit 4 can be provided by separation devices using silica gel distillation, membranes, and coated ceramic monoliths, for example. The preferred embodiments for an OBS unit 4 will be discussed in greater detail below. Also, as will be described in further detail below unlike prior fuel management systems, the present system provides for both control of the rate of production of the HRON and LRON fuels via the feed rate of IRON fuel to the OBS unit 4, in combination with consumption control based on availability of stored HRON and LRON fuels, and mechanisms for minimizing contamination of main tank 2 fuel with LRON fuel. Such control is provided continuously over the various cycles of operation of the engine 10.

With further reference to FIG. 1, the HRON fuel produced by the OBS unit 4 is either delivered through gravity feed or via a pump 6 to an HRON tank 8 for storage. Similarly, the LRON fuel produced by the OBS unit 4 is fed via variable feed pump 22, in this example, to an LRON tank 7 for storage. The controller 14 is programmed, as will be described in further detail below, for operating the present system to deliver individually or in a predetermined mixture at any given time fuel from the IRON tank 2, and/or LRON tank 7, and/or HRON tank 8 to the engine 10, dependent upon loading of the engine 10 at any given time. In one programming scheme, IRON fuel from the main tank 2 is delivered to the engine 10 only when the LRON tank 7 is empty. In one embodiment, the IRON fuel can be delivered from the main tank 2 to the engine 10 via pressure differential, or via a pump 23, as shown. Also, if the OBS unit 4 overproduces the LRON and/or HRON fuels, causing their associated tank 7, 8, respectively, to become full, the controller 14 is programmed to cause any further excess LRON and/or HRON fuel from the OBS unit 4 to be returned to the main tank as shown by the dashed lines. The return of either of the LRON and HRON fuels can be by gravity, in one example. Alternatively, a pump 16 can be operated for returning HRON fuel to the main tank 2, and a pump 26 is operable for returning LRON fuel to the main tank 2. Also, as shown in FIG. 1, excess HRON fuel can be returned to the OBS unit 4 by operation of a valve or a pump 18, to provide for recycling the permeate stream in the OBS unit 4, for example. Further note that a level sensor 25 provides signals to the controller 14 indicative of the level of fuel in the LRON tank 7.

As shown in FIG. 1, the feed rate of IRON fuel from the main tank 2 to the OBS unit 4, can be varied from 0.5 to 1.5 grams per second, in this example. A variable rate pump 24 is utilized in this example to control the feed rate, but other feed rate control means can be utilized.

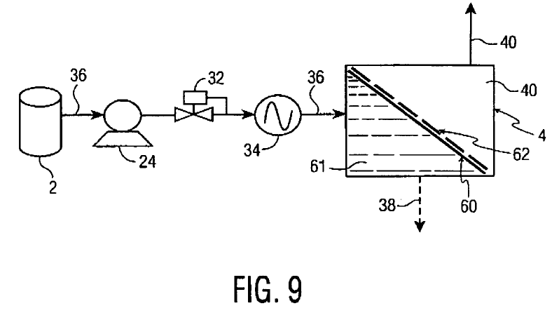

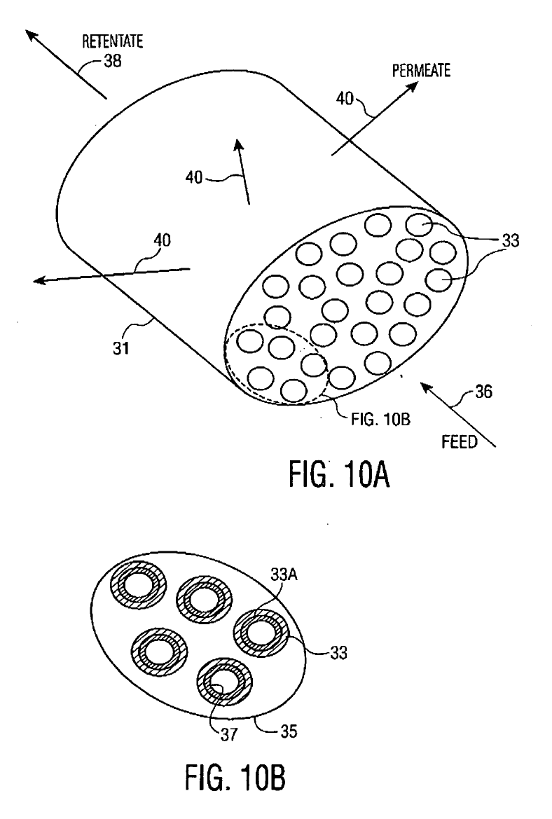

Through use of the previously mentioned permeate recycle mechanism, the net amount of fuel in HRON tank 8 can be varied, within controlled limits, when utilizing active recycle control. In one embodiment, a variable rate pump 18 is operable by controller 14 for varying the recycle rate from 0 to 0.4 g/s (grams per second). Alternatively, passive recycling can be utilized via overflow of HRON fuel from tank 8 when the tank is full. Note that the ranges of fuel flow suggested throughout this description are given for purposes of example only, and are not meant to be limiting. Further note that it is assumed that the flux across the membrane 62 (see FIGS. 9, 10A and 10B, as described below) of the OBS unit 4 is relatively constant. The rate of the permeate stream associated with HRON fuel can only be varied within a narrow range.

The Controller 14 is programmed for permitting the engine 10 to instantaneously draw fuel from the HRON and LRON tanks 8, 7, respectively, in any proportion. For example, if there is sufficient fuel in the HRON tank 8 and LRON tank 7, fuel may be delivered in a given proportion from the two tanks to engine 10. However, if for example the LRON tank 7 is empty and the HRON tank 8 contains sufficient fuel, controller 14 is operable for causing the system to deliver fuel as either a predetermined mixture of IRON fuel from the main tank 2 and HRON fuel from tank 8, or alternatively, only one of these fuels may be delivered to the engine 10 at a given time. In this regard, controller 14 is programmed in a preferred embodiment of the invention based upon the operating characteristics of the OBS unit 4, in terms of feed rate and the amount of HRON fuel produced, in combination with the instantaneous behavior or operating demands of engine 10 at any given time. The operational demands of engine 10 at such given times determines which of the aforesaid fuels to mix, and in what proportion, depending upon fuel availability in tanks 2, 7, and 8.

Further note that the control algorithms for programming controller 14, as will be described in greater detail below, are independent of the method of separation employed (the type of OBS unit 4 utilized). Also note that although the present system is described for use with an OBS unit 4 that separates the IRON fuel into only two grades of fuel, namely, HRON and LRON, the present system and methodology is applicable with modification for controlling the delivery of more than two grades of fuel produced by an OBS unit capable of delivering more than two grades of fuel.

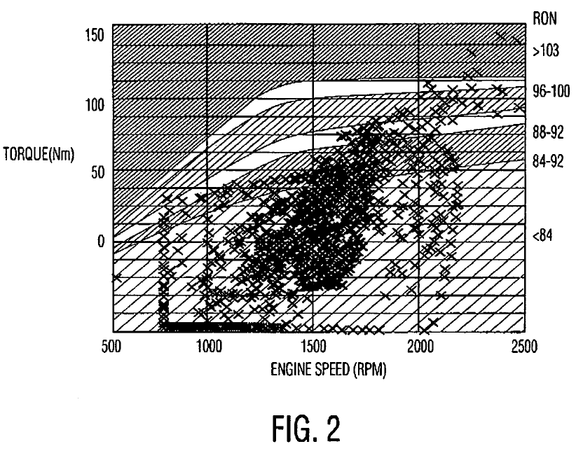

An Optimum RON Map is shown in FIG. 2 for mapping engine torque output against engine speed against the level of RON fuel required by the engine for optimal or most efficient operation. This mapping is represented by the following equation:

RON^{ideal}=f(Torque, speed, gear ratio, accelerator, velocity) (1). For ideal or optimal operation of engine 10, it should be provided with the proportion of fuel specified by the map of FIG. 2. However, when one of the normally available types of RON fuel is unavailable, controller 14 is programmed to deviate from the optimum RON map. Note that the optimal RON map of FIG. 2 was developed from a Los Angeles 4 drive cycle, in this example. Also, in this example, the IRON fuel can be 91 RON, the HRON fuel 103 RON, and the LRON 88 RON. However, the invention is not meant to be limited to these RON fuel values.

In a preferred embodiment of the invention, the controller 14 is programmed to match the requirements of the driver of an associated vehicle to the production characteristics of the OBS unit 4. It is possible to control the present system in three different manners, as follows:
The feed rate of the OBS unit 4 can be varied through use of a variable pump 24 from 0.5 to 1.5 grams per second, for example. In this manner, the production rate of the OBS unit 4 is controlled. Note that the obtainment of such feed rate variation or any other feed rates mentioned herein are not meant to be limiting, and are provided for purposes of example only.
Through a permeate recycle mechanism, the quantity of HRON fuel that is recycled to the OBS unit 4 can be varied within certain limits. For example, a variable rate pump 18 can be controlled for varying the recycle rate from 0 to 0.4 grams per second (g/s) for the present system, but this rate is not meant to be limiting.
The engine 10 can at any instant in time draw HRON fuel from the HRON tank 8, LRON fuel from the LRON tank 7, and IRON fuel from the main tank 2, in any proportion. In this example, the proportion is under the control of the controller 14 operating pump/valve 20, pump 22, and pump 26.
A pump 6 can provide a flow rate of 0.4 g/s of HRON fuel from OBS unit 4 to HRON tank 8, for example.
A variable rate pump 22 can provide a flow rate of 0.1 to 1.1 g/s for feeding LRON fuel from OBS unit 4 to LRON tank 7, for example.

In the preferred embodiment of the invention, the controller 14 is programmed to jointly control the instantaneous behavior of the OBS unit 4 via control of the feed rate thereto of IRON fuel, as previously mentioned, and the instantaneous demands of the engine 10 relative to which fuels to mix and in what proportion. Further note that in the system of FIG. 1, the pumps 16 and 26 can be considered optional, if as previously mentioned, gravity feed is utilized for returning HRON and/or LRON fuel to the main tank 2.

The control algorithms illustrated herein are independent of the method of separation employed, that is independent of the type of OBS unit 4 utilized. As previously mentioned, the OBS unit 4 can be provided by both a distillation method or by a membrane method for obtaining the desired fuel separation. The present method is also applicable with modification for utilizing an OBS unit 4 that separates the IRON fuel into more than two grades of RON fuel.

The present inventors recognize that the control algorithm or algorithms utilized must be capable of controlling the production rate of the OBS unit 4 to match the driver's requirements, that is the loading on the engine 10 at any given time. In other words, controller 14 must have the ability to change the feed rate of IRON fuel to the OBS unit 4 in a manner increasing the feed rate should the engine 10 demand more fuel of a particular type due to a driver's operating requirements. For the same reason, the controller 14 must have the ability to decrease the feed rate should that be necessary. Also, the controller 14 must be programmed to provide a fuel mixture that is matched to the present production of the OBS unit 4. For example, if a driver requires a relatively large amount of HRON fuel, and the HRON tank 8 is empty, it is then necessary for the controller 14 operate to feed retentate stream LRON and/or IRON from the main tank 2 to make up for the deficit of HRON fuel.

Typically, the fuel requirements of the engine 10 at any given time are partly determined by the requirements of the driver of the associated vehicle. The controller 14 of the present system is programmed to adapt to the requirements of different drivers relative to the fuel demands for the engine 10 at any given time. For example, the feed rate of IRON fuel from main tank 2 to the OBS unit 4 is varied relative to the driver's engine operating requirements at any given time. Also, in the preferred embodiment of the invention, the particular fuel or mixture of fuel delivered to engine 10 is matched to correspond to the rate of production of these fuels by the OBS unit 4 at any given time. For example, if at a given time, the engine 10 requires a higher proportion of HRON fuel at a time when the HRON tank 8 is empty, the controller 14 is programmed to deliver either LRON fuel from tank 7, or IRON fuel from tank 2, or a mixture thereof.

When LRON tank 7 is filled, it is then only desirable to return LRON fuel to the main tank 2, at times that a proportional amount of HRON fuel is also returned. The reason is that if only LRON fuel is returned to tank 2, the quality of fuel in the main tank 2 will be degraded. The control algorithms for programming controller 14 are designed to prevent only LRON fuel from being returned to main tank 2, whenever this is possible. One example of such control is to deliver LRON fuel to the engine 10 in a mixture with HRON and/or IRON fuel, depending upon the availability of HRON fuel at the time, even though the engine 10 operating demands may not require any LRON fuel at the time. In other words, the controller 14 is programmed to take compromising action when necessary at times that the LRON tank 7 is filled.

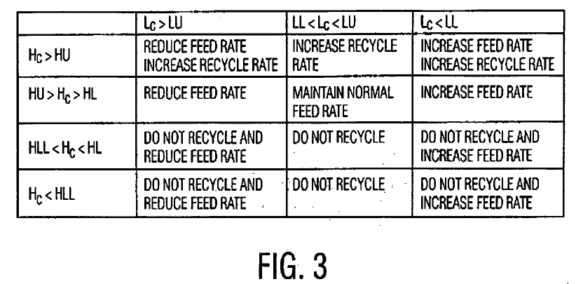

The design of the preferred algorithm for programming the controller 14 will now be described. Threshold levels of fuel were established for the HRON tank 8 and LRON tank 7. More specifically, a threshold level designated HL for HRON low, and optionally a yet lower level of fuel designated HLL for HRON low-low, and an upper fuel level HU for HRON upper, were established. In other words, the highest level of fuel to be detected in the HRON tank 8 is HU, the next lower level HL, and the lowest level HLL. Similarly, for the LRON tank 7, the highest level of fuel to be detected therein is designated LU for LRON upper, and the lowest level to be detected as LL for LRON lower. Also, the instantaneous levels of fuel in HRON tank 8 and LRON tank 7 are designated H_{C}, and L_{C}, respectively. It is further assumed that at any given time in operating the engine 10, the feed rate of IRON fuel to the OBS unit 4 can be substantially instantaneously increased or decreased, in order to increase or decrease the net production rate of HRON fuel (within limits, with recycle). It is also assumed that a mixture of the available fuel types can be delivered to the engine 10, as required. It is further assumed that the controller 14 can be programmed via the preferred algorithm to make successive changes, as required, in the mixture of fuel or the fuel to be delivered to the engine 10 at any given time, with such changes being made in substantially short intervals of time, preferably a second or less. A simple embodiment of the aforesaid control algorithm is shown in FIG. 3.

With further reference to FIG. 3, a few of the operational steps will be described in detail, in order to facilitate one's ability to readily interpret the algorithm. For example, when the instantaneous level of HRON fuel in tank 8 H_{C} is greater than the upper level of fuel in tank 8, if at that time the instantaneous level of LRON fuel L_{C} in tank 7 is greater than the upper level of fuel LU, the feed rate of IRON fuel to the OBS unit is reduced, and the recycle rate of HRON fuel from tank 8 to the OBS unit 4 is increased. Alternatively, under the same HRON fuel level conditions for HRON tank 8, if the instantaneous level of LRON fuel L_{C} in tank 7 is greater than the low level LL and less than the upper level LU of LRON fuel therein, the rate of HRON fuel recycled from tank 8 to OBS unit 4 is increased. Again, under the same aforesaid fuel levels in HRON tank 8, if the instantaneous level of LRON L_{C} is less than the low level of LRON LL in tank 7, the feed rate of IRON fuel from tank 2 to OBS unit 4 is increased, as is the recycle rate of HRON fuel from tank 8 to OBS unit 4. Other control features of the algorithm as shown in FIG. 3 are similarly interpreted.

The present system is operable for balancing the production and consumption of LRON fuel over a successively short measuring time period to substantially minimize, and preferably avoid, overflow LRON fuel back to the main tank 2. This is accomplished by controlling the feed rate of IRON fuel to the OBS unit 4 to in response to the position of the piston 90 in the accumulator 88, which indicates the amount of LRON fuel stored. When the stored LRON exceeds a pre-specified threshold LH, the feed rate to the OBS unit 4 is reduced. Similarly, when the LRON level reduces below LL, the feed rate is increased. In a preferred embodiment, the controlled mechanism is further programmed to monitor when the level of IRON fuel in the main tank 2 drops to a predetermined low level, such as 10% to 20% of capacity, to reduce the feed rate of IRON fuel from main tank 2 to the OBS unit 4 to a minimum of value, while at the same time meeting the HRON requirements of the engine 10 by feeding IRON fuel from the main tank 2 to the engine 10, to make up for any insufficiency of HRON fuel engine requirement at a given time. Through use of this extended control programming or mechanism, the degradation of the IRON fuel in the main tank is minimized at times when the IRON fuel is most susceptible to degradation by return of LRON fuel to the main tank 2, due to the low level of IRON fuel thereof.

When the level of fuel in the HRON tank 8 is higher than the threshold HL, the actual research octane number (RON) of the fuel being delivered to engine 10 is determined by first extracting the RON value from the optimum RON map of FIG. 2, in this example. As the engine demands change, the RON value will change in accordance with the aforesaid map, and is utilized for programming the controller at any instant in time to deliver the optimum fuel to the engine 10. Typically, the fuel delivered is a mixture of LRON and HRON fuel, but can be only HRON fuel or only LRON fuel, or only IRON fuel depending upon the RON value. Accordingly, in the preferred embodiment, Equation (2) as shown below is obtained:

RON^{actual}=RON^{ideal} (2).

As previously mentioned, the present system provides for both production and consumption control of the fuels. More specifically, consumption control is required in two particular cases, for example. The first case is when the HRON tank 8 has its fuel level drop to or below HLL, requiring in the preferred control strategy to only supply LRON or IRON fuel to the engine 10 at times when HRON fuel is actually demanded. In this manner, the probability of the HRON tank going totally empty is minimized. Also, when the LRON tank 7 has a level LU, which is close to being completely filled, it is desirable to increase consumption of the LRON fuel in order to prevent overflow of LRON fuel into the main tank 2, as previously discussed. In either case, the RON map of FIG. 2 must be modified, and when delivering fuel to a spark ignition internal combustion engine, the engine spark retard control can also be designed in order to insure that such changes in the fuel being delivered to the engine 10 produce no noticeable affect to the driver.

In another embodiment of the invention, a correction factor to the optimum RON map of FIG. 2 can be utilized under the aforesaid two conditions, as follows:

RON^{actual}=αRON^{ideal} (3)

α=g(torque, speed, gear ratio, accelerator, velocity) (4)

Note that the correction factor α can be made to depend on a plurality of engine parameters, including gear ratio and the accelerator velocity to account for the engine 10 instantaneous RON requirements. For example, if the engine 10 at a given time is in a high acceleration mode, typically requiring HRON fuel, α can be set close to or equal to 1. Under other circumstances, either LRON or IRON fuel can be substituted in larger quantities with the necessary level of spark retardation or advance such as high speed/fuel consumption, when operating a spark ignition internal combustion engine 10. In this latter example, α is made less than 1, which may result in a temporary reduction in fuel efficiency.

Similarly, in a high acceleration mode for a compression combustion engine (diesel or HCCI, for example), the control is effected through an examination of the cetane number required by the engine. If the optimum cetane number is not available, this can be inferred by sensing the noise due to knocking, whereby if the noise is excessive it can be reduced by changing the valve timing. More particularly, the basis for the control can also be provided for a compression combustion ignition engine (diesel or HCCI, for example), by the additional parameter of cetane number and an ideal cetane number map. The actual control, in addition to use of the ideal cetane number map, can be provided by appropriate parameters such as valve timing, injection timing, intake air temperature, or combination thereof to control knock. For example, for HCCI (high compression combustion ignition) engines, fuels having a range of 15 to 85 cetane number are believed viable. Fuels having cetane values in the low end of the range would be used for high engine loads, and fuels having values in the high end of the range would be used for low engine loads. For conventional diesel engines, the following equation “(5)” can be used to balance cetane number along with operating conditions to reduce diesel particulate matter:

δPM=C₁ΔCN+C₂ΔA-Ring+C₃ΔN-Ring (5)
where,
   δPM: PM (particulate matter) fraction reduction relative to TF-ao
   Δ: difference with respect to TF-ao CN: cetane number
   A-Ring: aromatic rings (wt %)
   N-Ring: naphthene rings (wt %)
   Ci: regression coefficient (i=1, 2, 3)
      C₁=0.0055
      C₂=0.017
      C₃=0.0065
      TF: TF-series fuels

As previously mentioned, when the HRON tank 8 fuel level is less than HLL, it is desirable to avoid further use of HRON fuel, in order to prevent associated pump wear, and other hardware damage. At such times, the controller 14 is programmed to provide either LRON or IRON fuel, or a mixture thereof, to the engine 10.

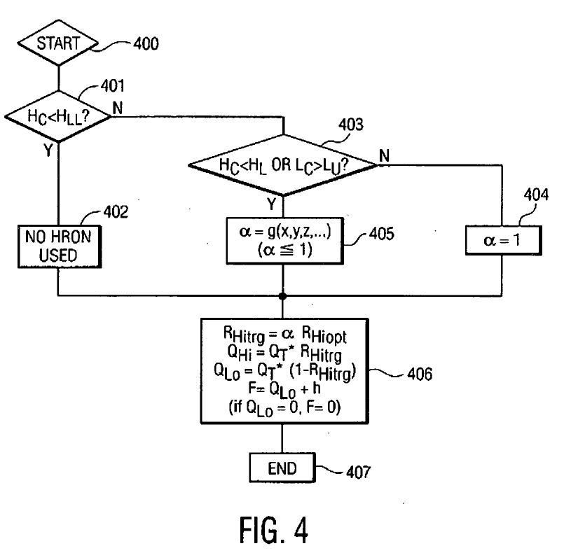

The flowchart showing the steps necessary for providing the aforesaid second algorithm example is shown in FIG. 4. The parameters shown in steps 401 through 406 will now be described. F is the feed rate of IRON fuel to the OBS unit 4. Q_{T} is the total fuel consumption of the engine 10 at any given time. Q_{Hi} is the HRON fuel consumption at a given time. Q_{Lo} is the LRON fuel consumption at a given time. R_{Hitrg} is the actual HRON fuel injection ratio, which is the ratio of Q_{Hi} to Q_{T}. R_{Hiopt} is the optimum HRON injection ratio (map), which is the proportion of HRON fuel supplied to the engine 10, as defined by the optimum RON map. H_{C} is the HRON instantaneous level of fuel in tank 8. H_{LL} is the lower fuel level limit of HRON fuel in tank 8. The correction factor is designated α, as previously indicated. The torque, speed, fuel injection ratio, and so forth are represented by x, y, z, . . . . The membrane flux is represented by h. L_{C} is the instantaneous level of fuel in the LRON tank 7. L_{U} is the LRON fuel upper threshold level in tank 7.

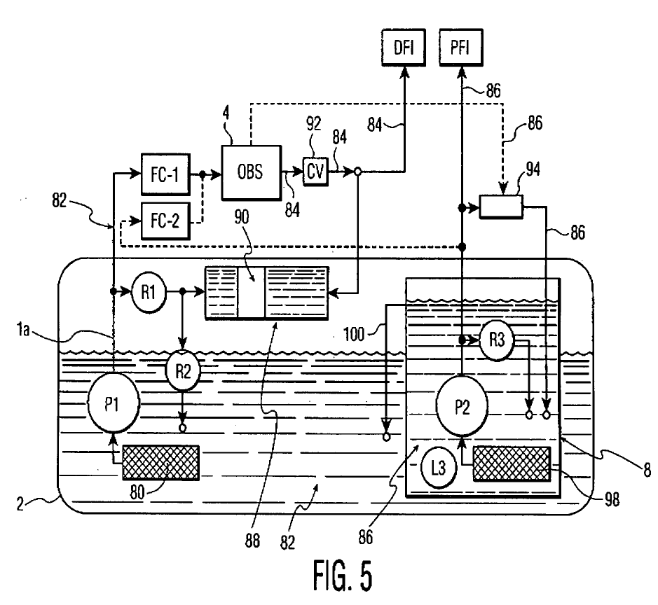

With reference to FIG. 5, another embodiment of the invention will now be described. IRON fuel 82 contained in the Main Tank 2 is drawn through filter 80 and pressurized by means of pump P1 against pressure regulators R1 and R2. In this example pressure regulator R1 was set to maintain a 100 kpa pressure differential above R2. Pressure regulator R2 was set to maintain a pressure of 200 kPag. Therefore the pressure provided by pump P1 was ˜300 kPag. Pressurized IRON fuel 82 flow rate is set by flow controller FC-1 to the OBS separation unit 4. Excess pressurized IRON fuel 82 is returned to the Main Tank 2 through pressure regulator R2.

Separated LRON fuel 84, and HRON fuel 86, from the OBS unit 4 are directed to the engine direct fuel injector DFI, and port fuel injector PFI, respectively, or to the storage volumes shown as accumulator 88 and HRON tank 8, respectively. LRON fuel 84 is provided to the direct fuel injection system injector DFI on demand. Excess LRON fuel 84 is directed to the accumulator 88. IRON fuel 82 displaced from the accumulator 88 is returned to the main tank 2 through the secondary pressure regulator R2. At the limit of the accumulator 88 volume, excess LRON fuel 84 flows into the main tank 2 along with excess IRON fuel 82 through pressure regulator R2. If demand for LRON fuel 84 exceeds the OBS unit 4 production rate, additional LRON fuel 84 and/or IRON fuel 82 is provided by means of the accumulator 88. The position of the LRON accumulator piston 90 is determined by means of a position sensor (not shown). A check valve prevents backflow to the OBS unit 4.

HRON fuel 86 produced by the OBS unit 4 is delivered to the HRON tank 8 by means of an eductor pump 94, or other suitable means. The HRON fuel 86 in the HRON tank 8 is pressurized by means of pump P2 after passing through a filter 98 with the pressure controlled by pressure regulator R3. Excess pressurized HRON fuel 86 returns to the HRON tank 8 through R3. The pressurized HRON fuel 86 is provided to the port fuel injector PFI and to the eductor pump 94, with excess fuel returning to the HRON tank 8. An overflow tube 100 is provided to allow excess HRON fuel 86 accumulated in the HRON tank 8 to overflow into the main tank 2. A float type or other suitable level sensor L3 provides a continuous measure of the level in the HRON tank 8.

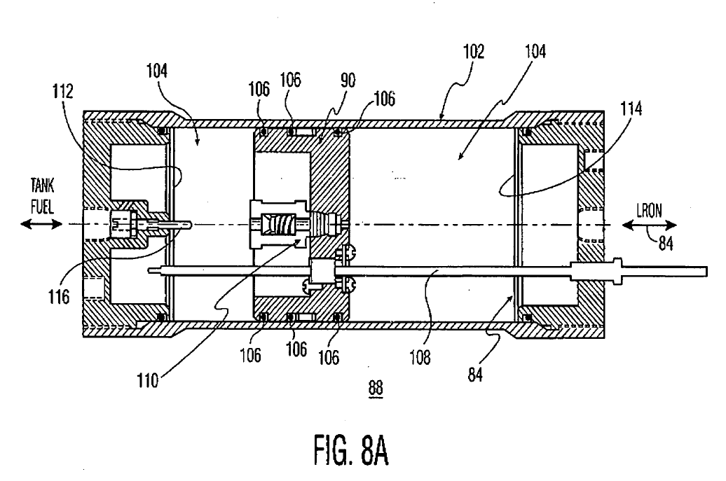

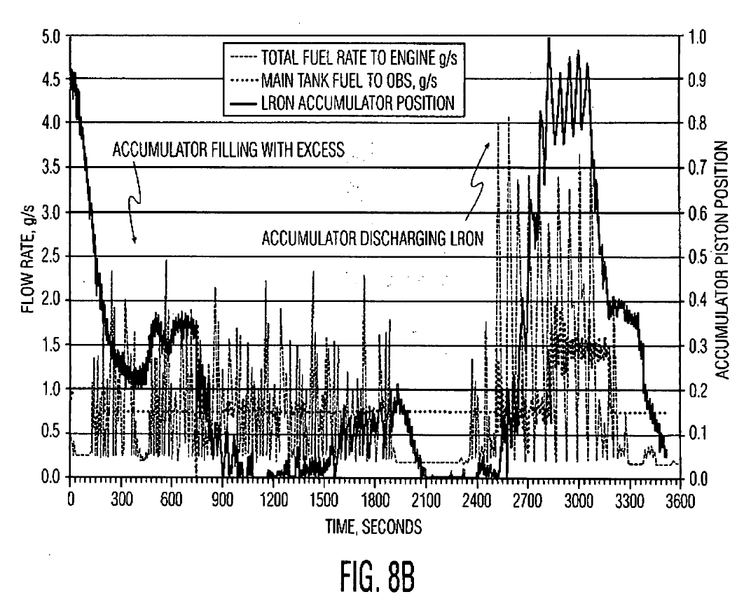

The LRON accumulator 88 assembly is shown in FIG. 8A, for another embodiment of the invention. The accumulator 88 consists of a piston 90 and cylindrical 102 providing a piston chamber 104 having a nominal displacement volume of 750 cm³ as used in experimental vehicle tests, for example. The piston 90 uses Teflon sealing rings 106 providing low resistance to movement such that the piston 90 travels freely with minimal differential pressure, i.e. <10 kPa. A position sensor 108, in an engineering experimental prototype was provided by a Transducers Direct LLC Model TD-140-6-A-1PB-001 Linear Potentiometer, which was used to determine the volume of LRON fuel 84 accumulated. The piston 90 incorporates a modified check valve 110, a Swagelok® SS-2-C2-1 or equivalent, for example, which provides sealing of the piston 112 during travel, but opens to allow the flow of fuel at the opposing ends of travel limited by the cylinder faces 112 and 114. With flow in the direction associated with the normal opening function of the check valve 110, the check valve 110 opens to allow IRON fuel 82 from main tank 2 to flow through the piston 90 when the piston travel is stopped by the cylinder face 114, providing IRON fuel 82 to the fuel injector DFI from the main tank 2 as required. When excess LRON fuel 84 is produced, the piston 90 travels in the opposite direction with the piston sealed by the check valve 110 until reaching the opposite cylinder face 112. As the piston 90 approaches the cylinder face 112, a pin 116 adjusted to push open the check valve 110 as the piston 90 approaches the cylinder face 112 is engaged to allow flow of LRON fuel 84 to the main tank against the back pressure regulator R2 (not shown, see FIG. 5).

In this example, an experimental test vehicle fitted with an OBS Onboard Separation System, Dual Fuel Injection Engine 10, and including a fuel tank modified to function as described in FIG. 5, was evaluated to demonstrate the control algorithms described above. The vehicle was driven on a test track at varying speeds and loads providing a range of fuel use and production rates.

The LRON accumulator 88 described in FIG. 8A was installed in the test vehicle fuel tank 2. FIG. 8B shows the movement of the accumulator piston 90 as measured by the position sensor 108 of FIG. 8A. In this test the control algorithm of the invention was set to make changes to the feed rate provided by flow controller FC-1 of IRON fuel 82 to OBS unit 4, at the accumulator 88 positions of 0.4 and 0.85, respectively, for the LRON Hi-Level and Low-Level triggers. Note the accumulator position sensor 108 reads zero when the cylinder 102 is filled either with LRON fuel 84, or with IRON fuel 82. IRON fuel 82 from the main tank 2 is delivered to the OBS unit 4 by flow controller FC-1 at an initial flow rate of 1.0 g/s, in this example. This rate was in excess of the fuel demand by the engine 10, and after 195 seconds the accumulator 88 piston 90 position reached the LRON hi-limit (position<0.4) and the flow rate was reduced to 0.75 g/s (grams per second). As the test continued, the flow rate of IRON fuel 82, in this example, remained at 0.75 g/s until the accumulator 88 Low-Limit was reached at 2846 seconds, at which time the IRON fuel 82 flow rate to the OBS unit 4 was increased to 1.5 g/s by the control algorithm. This rate was maintained during the more severe portion of the driving test. At 3188 seconds, the accumulator piston 90 position again moved through the Hi-Limit and the flow controller FC-1 set point again was reset to 0.75 g/s, as the engine 10 returned to idle conditions. At termination of the test the LRON accumulator 88 was essentially full of LRON fuel 84. The HRON fuel 86 level changed only slightly during this test and did not exceed the control limits, High or Low.

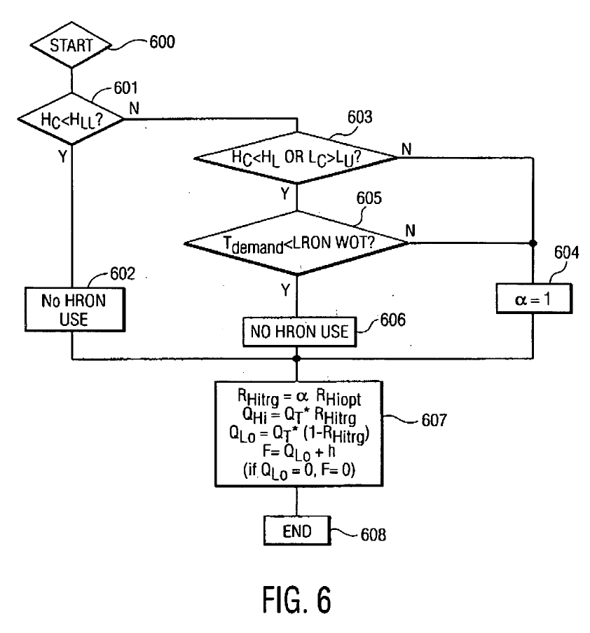

With further reference to the flowchart of FIG. 4, in a special case for the programming of the controller in operating the present system, the correction factor α can be set through use of other considerations than those associated with the aforesaid flowchart. Typically, if the torque and speed requirements of the engine can be met by use of LRON fuel only, the system can be programmed to avoid any use of HRON fuel. As a result, the flowchart of FIG. 4 can be modified to the simpler flowchart shown in FIG. 6. Most of the parameters and/or acronyms shown in FIG. 6 have already been defined for similar ones in the flowchart of FIG. 4. Additional parameters are for the maximum torque of the engine using only LRON fuel identified by LRON WOT. T_{demand} represents torque, speed, gear ratio, and so forth. Note that steps 600 through 604, and steps 607 and 608, relative to the flowchart of FIG. 6, are identical to steps 400 through 404, 406, and 407, respectively, of FIG. 4.

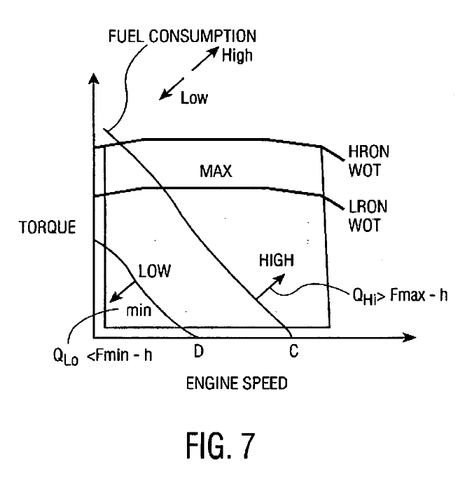

In FIG. 7 an engine mode and fuel consumption curve is shown. Torque is plotted against engine speed. As shown, the higher the torque requirements for the engine, the higher the fuel consumption, with the converse being true. Note also that (Fmin−h) represents the minimum feed rate minus the membrane flux. Also, (Fmax−h) represents the maximum feed rate minus the membrane flux. Also, as previously mentioned, Q_{Hi} represents the HRON fuel consumption at a given time, and Q_{Lo} represents the LRON fuel consumption at a given time. Note further that below an engine speed of “D” minimum fuel is used, between engine speeds of “D” to “C,” low fuel consumption is experienced, and above an engine's speed of “C” a high fuel consumption is experienced. Also note that once the torque demands exceed a particular level requiring the use of HRON fuel, an area of maximum fuel consumption is reached.

The correct setting for the various threshold values involved in the previously described algorithms depend upon the “transient” characteristics of each particular drive cycle utilized. For example, as previously indicated, the optimum RON map of FIG. 2 was established through use of the Los Angeles LA4 drive cycle. Regardless, if one utilizes very stringent values of the associated thresholds which are close to the HRON tank 8 and LRON tank 7, fluid level limits, threshold settings will increase the risk of overflow/underflow of the fuels, resulting in undesirable operating conditions. Contrariwise, through the use of very “loose” settings of the thresholds, it is likely that such settings will constrain the operation of the OBS unit 4, and ultimately the operation of the associated engine, resulting in poor engine performance and fuel efficiency. Ideally, based upon driving conditions, the thresholds can be established through use of a learning algorithm. For example, if a driver repeatedly and frequently obtains certain threshold limits as a result of driving with high temporary acceleration demands, for example, the preestablished limits can be altered to meet the requirements of that particular driver.

In summary, the present system and associated methodology provide for jointly controlling the production and consumption of fuels in a vehicle equipped with a plurality of fuel tanks each containing different RON grades of fuel. One objective of the present invention is to permit a driver to the greatest extent possible, based upon the driver's operating conditions, to obtain either a mixture of the grade of fuel or a single grade of fuel that the engine demands at any given time for greatest efficiency and performance. Additionally, the production of the fuels by the OBS unit 4 is ideally adapted to the driver's requirements, whether accelerating, decelerating, pulling a heavy load, climbing a hill, and so forth. In addition, the programmed control of the present system is operative to the greatest extent possible to prevent the return of LRON fuel into the main tank 2, in order to avoid degrading the quality of IRON fuel in the main 2.

Also, as indicated above, the uniquely developed algorithms serve to control the production of LRON and HRON fuels by the OBS unit 4 in a manner maintaining the content of the HRON tank 8 and LRON tank 7 between predetermined upper and lower thresholds or fluid levels. The control algorithm is dynamic in that depending upon the level of HRON fuel in tank 8, and LRON fuel in tank 7, the IRON fuel feed rate to the OBS unit 4 is changed, as is the recycle rate of HRON fuel to the OBS unit 4. In this manner, the levels of the LRON fuel in tank 7, and HRON fuel in tank 8 are maintained between upper and lower limits at all times, whenever possible.

In addition to the aforesaid production control, a consumption control algorithm is designed to maintain the HRON and LRON contents within the specified threshold. When this is achieved, a driver consumes fuel in accordance with the aforesaid precomputed optimum RON map of FIG. 2. The consumption control algorithm increases the consumption of either one or both of the HRON and LRON fuels if the level of each is equal to or above HU, and LU, respectively. Contrariwise, if these fuels are below their lower limits, HLL, LL, respectively, the algorithm programs controller 14 operates the system to deliver fuel to the engine 10 via the two-way accumulator 88. These fuels can be stored with LRON in accumulator 88, and IRON fuel in the main tank 2. The consumption control algorithm performs two functions: (1) it reduces consumption of HRON fuel when the level is below HL, and similarly increases the consumption of LRON fuel when level is above LU, and (2) it adapts engine 10 operation through spark advance and/or valve timing to reduce knocking, which may occur due to the use of non-optimal fuel. FIG. 6 shows how HRON fuel supply to the engine 10 can be modified during shortage (HRON tank content<HL).

In another embodiment of the invention, a learning algorithm that can modify the fuel level thresholds at slower timescales to adapt to patterns in driver behavior can be realized. The learning algorithm is configured to provide that when high loads are encountered during a shortage of HRON fuel, for example, the engine 10 is given a higher priority than maintaining the HRON tank 8 fuel content between thresholds HU and HL, for example. Similar coding would apply to the LRON tank 7 fuel levels. Also, the learning algorithm will be capable of changing tank level thresholds to more suitable values at a given time if the particular high engine loading occurs frequently.

As previously shown for the algorithms of FIGS. 4 and 6, consumption control is provided for terminating HRON fuel consumption whenever the level of HRON fuel in tank 8 is below HLL. Such action prevents hardware damage to components such as pumps, for example, as previously mentioned. Also, in another embodiment, the consumption control algorithm is designed to be operative with more than two threshold levels of fuel within their associated tanks, as previously described.

FIG. 9 shows a simplified block schematic diagram of components of the present system shown in FIG. 7 utilizing a membrane separation device for OBS unit 4 as taught in U.S. Provisional Application Ser. No. 60/830,914, filed on Jul. 14, 2006, for an “Improved Membrane Separation Process Using Mixed Vapor-Liquid Feed.” The teachings of the latter are incorporated herein by reference to the extent they do not conflict herewith. More specifically, with regard to the illustrated OBS unit 4, of this embodiment, the integrated heat exchanger 34 provides for partially vaporizing to maintain dual feed states relative to the IRON fuel feed, which is fed to the OBS unit 4 as both liquid and vapor. The term “partially vaporized” means there is sufficient vaporization to provide the optimal vapor liquid mixture to the membrane. The liquid portion 60 contacts and wets the pervaporization membrane 62. The IRON liquid 60 has an increased content of the preferred permeate (relative to the IRON feed 36), while the vapor 61 phase has an increased content of the preferred retentate. In this example, the preferred permeate is HRON fuel, and the preferred retentate is LRON fuel.

The pervaporization membrane 62 is a selective membrane, selected to preferentially permeate the preferred permeate. For this application, an aromatic selected membrane such as described in U.S. Pat. No. 5,670,052 can be employed, for example. The teachings of this Patent are incorporated herein by reference to the extent they do not conflict herewith. The selective pervaporization membrane 62 can include physical porous support means (not shown) such as Gortex™, for example capable of providing physical support of the selective pervaporization membrane 62 under the temperature, pressure, and other conditions to be encountered. Alternative supports can include sintered metal or ceramic porous media. A preferred support means includes an asymmetric porous media such as a porous ceramic tube or monolith having a microporous surface material, as will be described for another embodiment of the invention for the OBS unit 4.

In a preferred embodiment for the illustrated OBS unit 4 design, a cross-linked polyimide-polyadipate membrane polymer supported on a porous ceramic support means provides the membrane 62. Such configurations are taught in U.S. Provisional Application No. 60/836,319, filed on Aug. 8, 2006, for “Polymer-Coated Inorganic Membrane For Separating Aromatic and Aliphatic Compounds.” The teachings of the latter are incorporated herein by reference to the extent that they do not conflict herewith. FIGS. 10A and 10B illustrate an embodiment from this Application that is considered a preferred embodiment for the present invention, and uses tubular inorganic ceramic substrate. In FIG. 10A, a tubular inorganic substrate 30 is included for the OBS unit 4 in this embodiment. The inorganic substrate 31 can comprise silica or alumina, for example. As shown, in this example IRON fuel 36 is fed into a plurality of channels 33 within the porous inorganic substrate 31. The surfaces of the channels 33 can, in a preferred embodiment, comprise a porous inorganic material whose porosity differs from the bulk porosity of the substrate 31. Most preferably, the surface porosity of the channels 33 is less than or about equal to the aggregate polymer size of the associating polymer. As previously indicated, a cross-linked polyimide-polyadipate membrane polymer can be utilized. In FIG. 10B, an illustration of an exploded area 35 of FIG. 10A, illustrates that the channels 33 include an interior surface region 33A that may be formed by wash coating the interior surfaces of the channels 33 of substrate 31 to form a silica top coat, for example. The channels 33 having the optimal surface regions 33A are each coated with an associated polymer layer 37 to form the required membrane system. As shown in FIG. 10A, permeate (HRON fuel 40) from the membrane system is extracted radially and retentate (LRON fuel 38) exits axially, in this embodiment.

In summary, in one embodiment the present invention provides for controlling the production and consumption of fuel in a vehicle equipped with an OBS unit 4, an LRON tank 7, and an HRON tank 8, from amongst other components. The present system provides for producing HRON and LRON fuels from a feed of IRON fuel, and supplies the individual grade or a mix of the grades of fuel to the engine as required by its operating state at a given time. The system is adaptive to modifying the rate of production of the fuels in accordance with the engine demands.

The production rate control for the OBS unit 4 is provided by controlling the feed rate of the IRON fuel to the OBS unit 4 by setting the feed rate equal to the LRON use at a given time, combined with the OBS unit 4 membrane flux. Typically, the membrane flux is estimated, and a measurement is continuously made of the amount of the LRON fuel being used by the engine at a given time. The production rate control minimizes the main tank 2 degradation by lowering OBS unit 4 feed rate to a minimum value, whenever the level of IRON fuel in the main tank 2 is below a predetermined threshold.

As further illustrated above, a consumption control algorithm provides for reducing the consumption of HRON fuel during shortages of this fuel by providing correction factors to the optimum RON Map shown in FIG. 2. The correction factor, in the example given above, as a, provides for accounting for the state of the engine when a fuel shortage occurs, and the level in the HRON tank 8 is at a predetermined threshold value. In the instant where the present system is used with a spark ignition internal combustion engine, the associated control system may adjust spark advance/retardation as required for insuring proper engine performance. Also, as indicated above, whenever the level of HRON fuel in tank 8 drops to below a predetermined level HLL, the controller 14 is operative to terminate any further delivery of HRON fuel to the engine 10, in order to prevent damage to various of the system components, such as pumps. Also, as previously indicated, the present system can be modified to be operative with more than two or three RON values of fuel, as previously described.

Note that the IRON fuel can also be designated as a regular grade fuel having an intermediate autoignition temperature (IAT) fuel. Similarly, the HRON fuel can be designated as a low autoignition temperature (LAT) fuel whose autoignition temperature is lower than that of IAT fuel. Lastly, the LRON fuel can be designated as a high autoignition temperature (HAT) fuel whose autoignition temperature is higher than that of IAT fuel.

Also note that FIG. 2 can be modified to provide an optimal autoignition fuels map to determine the fuel requirements in terms of autoignition temperature values. The optimal autotignition temperature map can be developed from the following equation:

Autoignition Temperature^{ideal}=f(Torque, Speed, Gear ratio, accelerator velocity) (6)

The engine operating requirements can be matched to a plurality of market fuels by direct or indirect measurement of the quality of the LAT fuel produced by the OBS unit from each of the fuels.

Although various features of the present invention have been shown and described herein, they're not meant to be limiting. Those of skill in the art may recognize certain modifications to these embodiments, which modifications are meant to be covered by the spirit and scope of the appended claims. For example, in operating the OBS unit 4, the permeation rate can be set in excess of normal HRON demands, whereby the excesses passively recycled by overflow back to the OBS unit 4, as shown in FIG. 1, resulting in an increase in the RON value of the HRON fuel produced. Also, the present invention can be extended by matching the engine requirements to a plurality of market fuels by direct or indirect measurement of the quality of the HRON fuel being produced by the OBS unit 4. It also should be noted that the OBS unit 4 is not limited to the embodiments, therefore taught above, and can be provided by either one of silica gel, distillation, membranes, and coated ceramic monoliths, and so forth. The present invention can be extended further by matching an engine's operational requirements to a plurality of market fuels by direct or indirect measurement of the quality of HRON fuel produced by the OBS unit 4 from each of the market fuels. In addition, although this invention is primarily described above in terms of control of the autoignition property RON in association with a plurality of different grades of gasoline selectively fed to an internal combustion spark ignition engine, those skilled in the art should recognize that the various embodiments of the present invention are equally applicable to diesel and other internal combustion compression ignition engines, where the fuel ignition property is expressed in cetane number rather than RON. For example, with regard to High Compression Combustion Ignition (HCCI) engines, the inventors believe a 15 to 85 cetane number range of diesel fuels would be usable, whereby at high engine load fuels having lower cetane number would be used, and at low engine loads fuels having higher cetane numbers would be used. However, the range of cetane numbers is not meant to be limiting, and is dependent upon the type of diesel engine being used.

What is claimed is:

1. A method for managing the delivery of fuel to an internal combustion engine of a vehicle, comprising the steps of:
filling a main tank of said vehicle with a predetermined amount of regular fuel having an intermediate research octane number (IRON);
installing a low research octane number (LRON) tank in said vehicle for retaining LRON fuel, wherein said LRON fuel has a lower RON than said IRON fuel;
installing a high research octane number (HRON) tank in said vehicle for retaining HRON fuel, wherein said HRON fuel has a higher RON than said LRON and IRON fuels;
installing an onboard separation (OBS) unit in said vehicle;
controllably delivering IRON fuel from said main tank to said OBS unit, said OBS unit being operable for separating said IRON fuel into said HRON and LRON fuels, respectively;
controllably and selectively delivering HRON and LRON fuels from said OBS unit to said HRON and LRON tanks, respectively;
monitoring the operational requirements of said engine at any given time;
measuring independently the levels of fuel in both said HRON and LRON tanks;
controllably and selectively delivering to said engine either HRON fuel from said HRON tank, or LRON fuel from said LRON tank, or a mixture thereof, in response to said monitoring step;
controlling the production of HRON and LRON fuels by said OBS unit, and the consumption of these fuels by said engine at any given time, directly in response to both said monitoring and levels sensing steps, whenever the levels of fuel in said HRON and LRON tanks are within predetermined limits;
controlling the production and consumption of either one or both of said HRON and LRON fuels, respectively, in accordance with a predetermined algorithm, whenever the level of fuel in said LRON and/or HRON tanks decrease to a predetermined low limit, respectively;
recirculating HRON fuel from said HRON tank to either one or both of said OBS unit and said main tank, wherever the level of fuel in said HRON tank exceeds a predetermined high limit; and
recirculating LRON fuel from said LRON tank to either one or both of said OBS unit and said main tank, whenever the level of fuel in said LRON tank exceeds a predetermined high limit.

2. A method for managing the delivery of fuel to an internal combustion engine of a vehicle, comprising the steps of:
filling a main tank of said vehicle with a predetermined amount of regular fuel having an intermediate research octane number (IRON);
installing a low research octane number (LRON) tank in said vehicle for retaining LRON fuel, wherein said LRON fuel has a lower RON than said IRON fuel;
installing a high research octane number (HRON) tank in said vehicle for retaining HRON fuel, wherein said HRON fuel has a higher RON than said LRON and IRON fuels;
installing an onboard separation (OBS) unit in said vehicle;
controllably delivering IRON fuel from said main tank to said OBS unit, said OBS unit being operable for separating said IRON fuel into said HRON and LRON fuels, respectively;
controllably and selectively delivering HRON and LRON fuels from said OBS unit to said HRON and LRON tanks, respectively;
monitoring the operational requirements of said engine at any given time;
measuring independently the levels of fuel in both said HRON and LRON tanks;
controllably and selectively delivering to said engine either HRON fuel from said HRON tank, or LRON fuel from said LRON tank, or a mixture thereof, in response to said monitoring step;
controlling the production of HRON and LRON fuels by said OBS unit, and the consumption of these fuels by said engine at any given time, directly in response to both said monitoring and levels sensing steps, whenever the levels of fuel in said HRON and LRON tanks are within predetermined limits; and
controlling the production and consumption of either one or both of said HRON and LRON fuels, respectively, in accordance with a predetermined algorithm, whenever the level of fuel in said LRON and/or HRON tanks decrease to a predetermined low limit, respectively.

3. The method of claim 2, further including the step of:
controllably delivering HRON fuel from said OBS unit to said IRON tank whenever said HRON tank is filled to a predetermined level.

4. The method of claim 2, further including the step of:
delivering LRON fuel from said LRON tank to said IRON tank, whenever said LRON tank is filled to a predetermined level.

5. The method of claim 2, further including the step of:
controllably delivering IRON fuel from said main tank to said engine, whenever the levels of HRON and LRON fuels are below predetermined levels in said HRON tank and LRON tank, respectively.

6. The method of claim 2, wherein said monitoring step includes the steps of:
sensing the torque versus engine speed of said engine at any given time; and
using an optimal RON map to determine the RON fuel requirement from the sensed torque and engine speed.

7. The method of claim 6, further including the step of developing said optimal RON map from the following equation:
RON^{ideal}=f(Torque, speed, gear ratio, accelerator velocity).

8. The method of claim 2, further including the step of controllably recycling HRON fuel from said HRON tank to said OBS unit in the event of the fuel exceeding a predetermined level in said HRON tank.

9. The method of claim 2, further including the step of matching the engine operating requirements of a driver of said vehicle to the production characteristics of said OBS unit.

10. The method of claim 8, further including the step of controllably recycling LRON fuel from OBS unit to said IRON tank in the event of overfilling said LRON tank.

11. The method of claim 2, further including the step of terminating the delivery of HRON fuel to said engine if the level thereof in said HRON tank drops to below a predetermined low low level HLL.

12. The method of claim 8, further including the steps of:
designating threshold levels of fuel in said HRON tank, wherein the thresholds are HL (for HRON fuel low), HLL (for HRON fuel low-low), HU (for HRON fuel upper), and Hc (for instantaneous content);
designating threshold levels of fuel in said LRON tank, wherein the thresholds are LU (for LRON fuel upper), LL (for LRON fuel lower), and L_{C} (for instantaneous content); and
applying the following control algorithm in response to measured threshold levels at any given time:

| | L_{c} > Lu | LL < L_{c} < LU | L_{c} < LL |
|---|---|---|---|
| H_{c} > HU | Reduce IRON | Increase | Increase IRON |
| | feed rate | HRON | feed rate |
| | Increase HRON | recycle | Increase HRON |
| | recycle rate | rate | recycle rate |
| HU > H_{c} > | Reduce IRON | Maintain | Increase IRON |
| HL | feed rate | normal | feed rate |
| | | IRON feed | |
| | | rate | |
| HLL < H_{c} < | Do not recycle | Do not | Do not recycle |
| HL | HRON and reduce | recycle | HRON and increase |
| | IRON feed rate | HRON | IRON feed rate |
| H_{c} < HLL | Do not recycle | Do not | Do not recycle |
| | HRON and reduce | recycle | HRON and increase |
| | IRON feed rate | HRON | feed IRON rate |

13. The method of claim 2, further including the step of matching the engine operational requirements to a plurality of market fuels by direct or indirect measurement of the quality of HRON fuel produced by said OBS unit from each of the fuels.

14. The method of claim 6, further including the step of:
applying a correction factor to said RON map in response to said levels measuring step indicating either one of the occurrence of the level of fuel in said HRON dropping to or below a predetermined level HLL, or that said LRON tank is close to being filled, whereby in the former case it is preferred to deliver either IRON or LRON fuel to said engine, and in the latter case it is preferred to increase the delivery of LRON fuel to said engine.

15. The method of claim 14, further including the step of terminating the delivery of HRON fuel to said engine in response to said levels measuring step indicating that the level of HRON fuel in said HRON tank has dropped to below HLL.

16. The method of claim 2, further including the step of selecting said OBS unit from one of a group of separation mechanisms consisting of silica gel, distillation, membranes, and polymer ceramic monoliths.

17. The method of claim 2, further including for providing said OBS unit, the steps of:
forming a tubular porous inorganic ceramic substrate having a plurality of channels extending inward from one end;
coating the channels with an associated polymer;
feeding said IRON fuel into said plurality of channels;
extracting said HRON fuel radially from said substrate; and
extracting said LRON fuel axially from said substrate.

18. The method of claim 2, further including the step of delivering LRON fuel to a direct fuel injection system of said engine.

19. The method of claim 18, further including the step of delivering IRON fuel to said direct fuel injection system in the event of insufficient LRON fuel being available at a given time.

20. The method of claim 2, further including the step of delivering HRON fuel to a port fuel injection system of said engine.

21. The method of claim 2, further including the step of forming said LRON tank from a two-way piston accumulator.

22. The method of claim 21, further including the step of positioning said two-way piston accumulator between said main tank for receiving IRON fuel therefrom, and said OBS unit for receiving LRON fuel therefrom at times that excess LRON fuel is produced, said accumulator including a piston and a check valve mechanism, whereby whenever the pressure of said IRON fuel exceeds that of said LRON fuel, said piston moves in one direction with said check valve being open for permitting IRON fuel to flow through said piston to a fuel injector of said engine, and whenever the pressure of said LRON fuel exceeds that of said IRON fuel, said piston moves in an opposite direction with said check valve closed for drawing LRON fuel into said accumulator, and when said piston moves in the opposite direction to an interior cylinder face of said accumulator said check valve opens for permitting LRON fuel to flow from said accumulator into said main tank.

23. The method of claim 22, wherein said measuring step includes the step of sensing the position of said piston within said accumulator to determine the level of LRON fuel therein at any given time.

24. A vehicle mounted fuel management system for delivering individually and/or in different mixtures a plurality of different grades of research octane number (RON) fuel to an associated internal combustion engine, comprising:
a main tank for containing a fuel having an intermediate research octane number (IRON);
an on-board separation (OBS) unit receptive of IRON fuel from said main tank, said OBS unit being operable for separating said IRON fuel into at least a high research octane number (HRON) fuel, and a low research number (LRON) fuel, of higher and lower RON than said IRON fuel, respectively;
a variable speed pump for feeding IRON fuel from said main tank to said OBS unit;
an HRON tank for receiving and containing HRON fuel from said OBS unit;
an LRON tank for receiving and containing LRON fuel from said OBS unit;
means for controllably and selectively delivering either HRON fuel from said HRON tank, or LRON fuel from said LRON tank, or a mixture thereof to said engine, in response to the operational requirements of said engine at any given time; and
means for controlling the speed of said pump to obtain a feed rate of said IRON fuel to said OBS unit, to control the latter's production of HRON and LRON fuels to match the demand for or consumption of these fuels by said engine at any given time.

25. The fuel management system of claim 24, wherein said OBS unit is selected from one of a group of separation mechanisms consisting of silica gel, distillation, membranes, and polymer coated ceramic monoliths.

26. The fuel management system of claim 24, wherein said OBS unit includes:
a tubular porous inorganic ceramic substrate having a plurality of channels extending inward from one end; and
an associating polymer coated on said channels, said channels being configured for receiving IRON fuel from said pump, whereby HRON fuel is extracted radially from said substrate, and LRON fuel is extracted axially from said substrate.

27. The fuel management system of claim 24, wherein said LRON tank consists of a two-way piston accumulator connected between said main tank and said OBS unit.

28. The fuel management system of claim 27, wherein said accumulator includes:
a cylindrical housing;
a moveable piston mounted within said housing; and
a two-way check valve mechanism centrally located in said piston, whereby whenever the pressure of said IRON fuel at one end of said housing exceeds the pressure of LRON fuel at the other end of said housing, said check valve opens to permit IRON fuel to flow through said accumulator to said engine, and whenever the pressure of the LRON fuel exceeds that of said IRON fuel, said piston moves toward the one end of said housing with said check valve in a closed position, drawing LRON fuel into said housing.

29. The fuel management system of claim 28, wherein said accumulator further includes means for opening said check vale when said piston moves to an extreme at the one end of said housing, for permitting LRON fuel to flow from said accumulator into said main tank.

30. The fuel management system of claim 24, further including:
means for measuring independently the levels of fuel in said LRON and HRON tanks, respectively; and
means for monitoring the operational requirements of said engine at any given time;
said delivering means and said pump speed control means each being directly responsive to said levels measuring means and said monitoring means, whenever the levels of fuel in said HRON and LRON tanks are within predetermined levels; and
said delivering means and said pump speed control means each being operable in accordance with a predetermined algorithm, in response to the levels of fuel in said HRON and/or LRON tanks not being within predetermined limits.

31. The fuel management system of claim 29, further including:
first measuring means for measuring the level of LRON fuel in said accumulator;
second measuring means for measuring the level of HRON fuel in said HRON tank;
means for monitoring the operational requirements of said engine at any given time;
said delivering means and said pump speed control means each being directly responsive to said first and second measuring means, and said monitoring means, whenever the levels of LRON fuel and HRON fuel are within predetermined limits; and
said delivering means and said pump speed control means each being responsive to a predetermined algorithm, whenever the level of LRON fuel and/or HRON fuel are within predetermined limits.

32. A method for managing the delivery of fuel to an internal combustion engine of a vehicle, comprising the steps of:
filling a main tank of said vehicle with a predetermined amount of regular fuel having an intermediate autoignition temperature (IAT);
controllably delivering IAT fuel from said main tank to an on-board separation (OBS) unit of said vehicle, said OBS unit being operable for separating said IAT fuel into a high autoignition temperature (HAT) fuel and a low autoignition temperature (LAT) fuel, higher and lower than said IAT fuel, respectively;
delivering LAT fuel from said OBS unit to an LAT tank of said vehicle;
delivering HAT fuel from said OBS unit to an HAT tank of said vehicle;
monitoring the operational requirements of said engine at any given time;
controllably and selectively delivering either LAT fuel from said LAT tank, or HAT fuel from said HAT tank, or a mixture thereof to said engine, in response to said monitoring step;
measuring independently the levels of fuel in both said LAT and HAT tanks;
controlling both the production of said LAT and HAT fuels by said OBS unit, and the consumption of these fuels by said engine, in response to said measuring step, and to said monitoring step, whenever the level of fuel in said LAT and HAT tanks is within predetermined limits; and
controlling the production and consumption of LAT and HAT fuels in accordance with a predetermined algorithm, whenever the level of fuel in said LAT tank or HAT tank is not within predetermined limits.

33. The method of claim 32, wherein said internal combustion engine consists of a diesel type compression combustion ignition engine, whereby said method further includes the steps of designating each of said IAT, LAT, and HAT fuel in terms of cetane number.

34. The method of claim 33, wherein said diesel engine is an HCCI engine, said method further including the steps of:
selecting said LAT fuel to have a cetane number of 15; and
selecting said HAT fuel to have a cetane number of 85.

35. The method of claim 33, wherein said cetane numbers are selected in accordance with the following equation:
δPM=C₁ΔCN+C₂ΔA-Ring+C₃ΔN-Ring
where, δPM:
PM (particulate matter) fraction reduction relative to TF-ao
Δ: difference with respect to TF-ao CN: cetane number
A-Ring: aromatic rings (wt %)
N-Ring: naphthene rings (wt %)
Ci: regression coefficient (i=1, 2, 3)
C₁=0.0055
C₂=0.017
C₃=0.0065
TF: TF-series fuels

36. The method of claim 32, wherein said engine is a spark ignition internal combustion engine, whereby said method further includes the steps of designating each of said IAT, LAT, and HAT fuels in terms of RON (Research Octane Number).

37. The method of claim 32, further including the step of:
controllably delivering LAT fuel from said OBS unit to said main tank whenever said LAT tank is filled to a predetermined level.

38. The method of claim 32, further including the step of:
controllably delivering intermediate IAT fuel from said main tank to said engine whenever LAT and HAT fuels are unavailable.

39. The method of claim 32, wherein said monitoring step includes the steps of:
sensing the torque versus engine speed of said engine at any given time; and
using an optimal autoignition temperature fuels map to determine the fuel requirement in terms of autoignition temperature value from the sensed torque and engine speed.

40. The method of claim 39, further including the step of developing said optimal autoignition temperature map from the following equation:
Autoignition Temperature=f(Torque, speed, gear ratio, accelerator velocity).

41. The method of claim 32, further including the step of matching the engine operating requirements to a plurality of market fuels by direct or indirect measurement of the quality of the LAT fuel produced by said OBS unit from each of the fuels.

42. The method of claim 32, further including the step of controllably recycling LAT fuel from said LAT tank to said OBS unit in the event of filling said LAT tank to a predetermined level.

43. The method of claim 32, wherein said step of controllably delivering IAT fuel from said main tank to said OBS unit, includes the step of equating short term HAT fuel production by the latter to short term HAT consumption by said engine via use of the formula:
F=L+h
wherein F is the gross mass feed rate (IAT fuel from main tank plus LAT fuel recycled from said LAT tank), L is the estimated average HAT fuel consumption rate, and h is the LAT fuel total production rate.

44. The method of claim 32, further including the step of terminating the delivery of LAT fuel to said engine if the level thereof in said LAT tank drops to below a predetermined level HLL.

45. The method of claim 32, further including the step of preheating said IAT fuel before its delivery to said OBS unit.

46. The method of claim 32, further including the step of delivering HAT fuel to a direct fuel injector of said engine.

47. The method of claim 46, further including the step of delivering IAT fuel to said direct fuel injector in the event of insufficient HAT fuel being available at a given time.

48. The method of claim 32, further including the step of delivering LAT fuel to a port fuel injector of said engine.

49. The method of claim 39, further including the step of:
applying a correction factor to said autoignition temperature fuels map in response to said level measuring step indicating that the level of LAT fuel in said LAT tank has dropped below a first threshold level HL, but is above a lower level HLL.

50. The method of claim 49, further including the step of terminating the delivery of LAT fuel to said engine in response to said level measuring step indicating that the level of LAT fuel in said LAT tank has dropped to below HLL.

51. The method of claim 32, further including the step of selecting said OBS unit from one of a group of separation mechanisms consisting of silica gel, distillation, membranes, and polymer coated ceramic monoliths.

52. The method of claim 32, further including for providing said OBS unit, the steps of:
forming a tubular porous inorganic ceramic substrate having a plurality of channels extending inward from one end;
coating the channels with an associated polymer;
feeding said IAT fuel into said plurality of channels;
taking said LAT fuel radially from said substrate; and
taking said HAT fuel axially from said substrate.

53. The method of claim 39, wherein said internal combustion engine consists of a spark ignition internal combustion engine, whereby said method further includes the steps of designating each of said IAT, LAT, and HAT fuels in terms of RON (Research Octane Number).

54. The method of claim 53, wherein said autoignition fuels map consists of a RON Map to determine the RON fuel requirement from the sensed torque and engine speed.

55. The method of claim 39, wherein said internal combustion engine consists of a diesel type compression combustion ignition engine, whereby said method further includes the steps of designating each of said IAT, LAT, and HAT fuel in terms of cetane number.

56. The method of claim 55, wherein said autoignition fuels map consists of a Cetane Map to determine the cetane fuel requirement from the sensed torque and engine speed.

57. In a motorized vehicle including a main fuel tank, an on-board separation (OBS) unit, a low autoignition temperature (LAT) fuel tank, a high autoignition temperature (HAT) fuel tank, and an internal combustion engine, a method for selectively delivering fuel from one or a combination of said main tank, OBS unit, LAT tank, and HAT tank, to said engine, comprising the steps of:
filling said main tank with a predetermined amount of fuel having an intermediate autoignition temperature (IAT);
controllably delivering fuel from said main tank to said OBS unit;
operating said OBS unit to produce an LAT grade fuel, and a high autoignition temperature (HAT) fuel;
delivering said LAT fuel from said OBS unit to said LAT tank;
delivering said HAT fuel from said OBS unit to said HAT tank;
controllably delivering said HAT fuel from said HAT tank to said engine in a first mode of operation;
controllably delivering LAT fuel from said LAT tank to said engine in a second mode of operation;
sensing the level of LAT fuel in said LAT tank;
controllably delivering LAT fuel from said OBS unit to said main tank, in response to said LAT level sensing step, at times that said LAT tank is filled to a predetermined level;
controllably recycling LAT fuel from said LAT tank to said OBS unit, in response to said level sensing step, at times that said LAT tank is filled to a predetermined level;
sensing the level of HAT fuel in said HAT tank;
controllably delivering said HAT fuel from said HAT tank to said main tank, in response to said HAT level sensing step, at times that said HAT tank is filled to a predetermined level;
controllably delivering IAT fuel from said main tank to said engine in a third mode of operation; and
controlling the production of LAT and HAT fuels by said OBS unit both in response to said LAT and HAT level sensing steps, and to match the demand for these fuels by said engine at any given time.
